(19) United States
(12) Patent Application Publication
(10) Pub. No.: US 2013/0180673 A1
(43) Pub. Date: Jul. 18, 2013

(54) HIGH SPEED DOOR MECHANISM

(71) Applicants: Rami Hashimshony, Moshav Aviel (IL); Oded Shani, Rishon LeZion (IL)

(72) Inventors: Rami Hashimshony, Moshav Aviel (IL); Oded Shani, Rishon LeZion (IL)

(21) Appl. No.: 13/743,396

(22) Filed: Jan. 17, 2013

Related U.S. Application Data
(60) Provisional application No. 61/587,683, filed on Jan. 18, 2012.

(51) Int. Cl. E05F 15/08

(52) U.S. Cl. CPC E05F 15/083
USPC 160/188

(57) ABSTRACT

A sliding door apparatus including a plurality of slat support elements, each including force-transfer members, a movement member and slat mounting members, the slat support elements being pivotally connected to one another and arranged for the movement members to travel along a track which has at least one straight track portion and at least one curved track portion, a plurality of slats attached to the slat mounting members, and a drive mechanism arranged to impart a driving force to the force-transfer members of the slat support elements so that the movement members travel along the track and pivot with respect to each other when passing through the at least one curved track portion.

### REFERENCE TO OTHER APPLICATIONS

This application claims priority from U.S. Provisional Patent Application 61/587,683, filed Jan. 18, 2012, which is incorporated herein by reference.

### FIELD OF THE INVENTION

The present invention relates generally to mechanisms for opening and closing sliding doors (that is, doors whose movement is guided in tracks, such as overhead sliding doors), and particularly to a high speed, quiet mechanism for opening and closing such sliding doors.

### BACKGROUND OF THE INVENTION

Many mechanisms exist for opening and closing overhead sliding doors, but they suffer from relatively loud and/or slow operation.

### SUMMARY OF THE INVENTION

The present invention relates to a high speed, quiet mechanism for opening and closing overhead sliding doors, as is described below.

There is thus provided in accordance with an embodiment of the present invention a sliding door apparatus including a plurality of slat support elements, each including force-transfer members, a movement member and slat mounting members, the slat support elements being pivotally connected to one another and arranged for the movement members to travel along a track which has at least one straight track portion and at least one curved track portion, a plurality of slats attached to the slat mounting members, and a drive mechanism arranged to impart a driving force to the force-transfer members of the slat support elements so that the movement members travel along the track and pivot with respect to each other when passing through the at least one curved track portion. The slat support element assembly enables two basic functions, namely, engagement with the drive mechanism (driving wheel) to transfer forces, and serving as a flexible chain to follow a curve.

In accordance with an embodiment of the present invention the drive mechanism is positioned to impart the driving force at a location along the at least one straight track portion.

In accordance with another embodiment of the present invention the drive mechanism is positioned to impart the driving force at a location along the at least one curved track portion.

In accordance with an embodiment of the present invention the force-transfer members include teeth and the drive mechanism includes a gear that meshes with the teeth.

In accordance with an embodiment of the present invention the slat support elements are straight.

In accordance with another embodiment of the present invention the slat support elements are curved to match a curvature of the at least one curved track portion.

In accordance with an embodiment of the present invention the slats are removable from and attachable to the slat mounting members without removing the slat support elements from the track.

In accordance with an embodiment of the present invention the slats provide thermal insulation.

In accordance with an embodiment of the present invention the slat support element includes a metal layer sandwiched between non-metallic layers.

### BRIEF DESCRIPTION OF THE DRAWINGS

The present invention will be understood and appreciated more fully from the following detailed description taken in conjunction with the drawings in which:

FIG. 1 is a simplified perspective illustration of a sliding door apparatus (an overhead sliding door with the opening and closing mechanism), in accordance with an embodiment of the present invention.

FIG. 2A is a simplified illustration of a drive wheel positioned on a linear track path for slats of the sliding door, in accordance with an embodiment of the present invention.

FIG. 2B is a simplified illustration of a drive wheel positioned on a curved track path for slats of the sliding door, in accordance with an embodiment of the present invention.

FIGS. 3A and 3B are simplified upper and lower perspective illustrations, respectively, of the opening and closing mechanism, in accordance with an embodiment of the present invention.

FIGS. 4A and 4B are simplified exploded and pictorial illustrations, respectively, of a construction of slat support elements, in accordance with an embodiment of the present invention.

FIG. 5 is a simplified illustration of a slat attached to a slat support element, in accordance with an embodiment of the present invention.

FIG. 6 is a simplified illustration of detachment of the slat from the slat support element, in accordance with an embodiment of the present invention.

FIG. 7 is a simplified illustration of a slat attached to a slat support element, in accordance with another embodiment of the present invention.

FIGS. 8A, 8B and 8C are simplified front view, exploded and sectional illustrations, respectively, of a slat support element, in accordance with an embodiment of the present invention, FIG. 8C being taken along lines A-A in FIG. 8A.

### DETAILED DESCRIPTION OF EMBODIMENTS

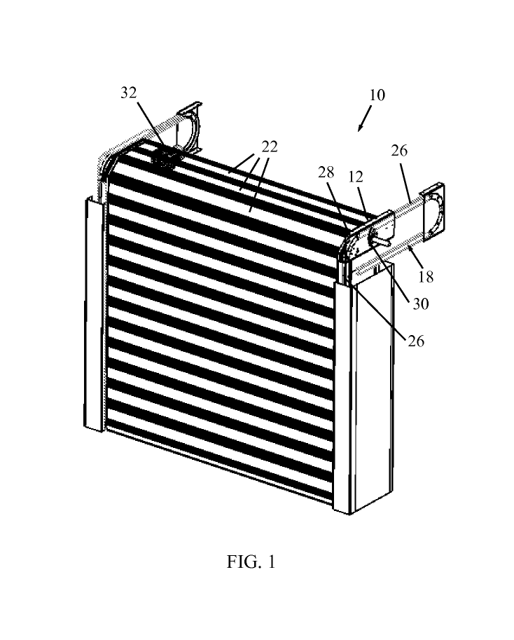

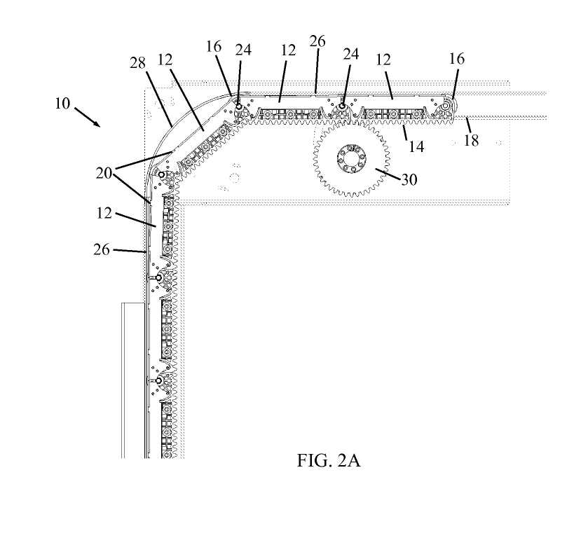

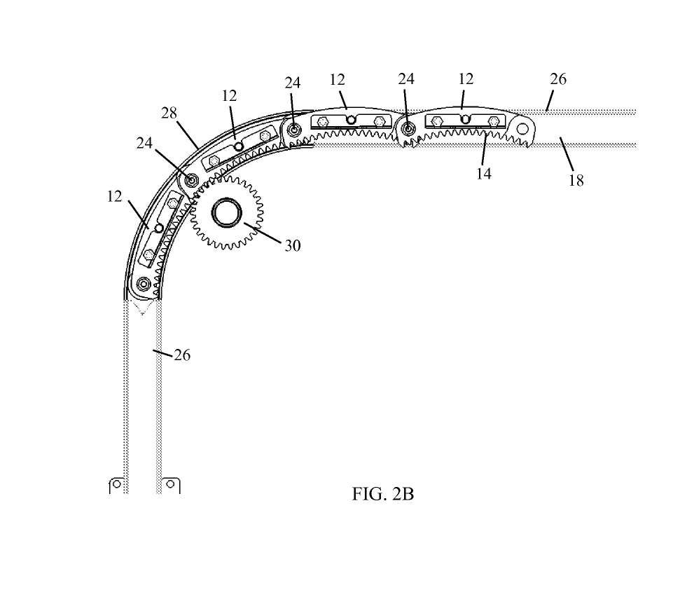

Reference is now made to FIGS. 1 and 2A, which illustrate sliding door apparatus 10, in accordance with a non-limiting embodiment of the present invention.

Sliding door apparatus 10 includes a plurality of slat support elements 12 (FIG. 2A), each of which includes force-transfer members 14 (FIG. 2A), such as teeth. Each slat support element 12 includes a movement member 16 (FIG. 2A), such as a roller (could alternatively be a slider) that travels along a track 18 (e.g., a U-shaped channel). Each slat support element 12 also includes slat mounting members 20 (FIG. 2A) for mounting thereon slats 22 (FIG. 1), as will be described more in detail below. Each door slat 22 preferably has at least two slat support elements 12, one on each side (left and right) of the slat length. Slat support elements 12 are pivotally connected to one another at pivots 24 (FIG. 2A), which may simply be the central axle of movement member 16. Track 18 has one or more straight track portions 26 and one or more curved track portions 28.

A drive mechanism 30 is arranged to impart a driving force to the force-transfer members 14 of slat support elements 12 so that the movement member 16 travel along track 18 and pivot with respect to each other when passing through the curved track portion 28. In accordance with an embodiment of the present invention, drive mechanism 30 includes a gear that meshes with teeth 14. An actuator 32 (FIG. 1), such as motor, is operatively connected to drive mechanism 30 for rotating the gear.

In the embodiment of FIG. 2A, drive mechanism 30 is positioned to impart the driving force at a location along straight track portion 26. In this embodiment, slat support elements 12 are straight.

In accordance with another embodiment, shown in FIG. 2B, drive mechanism 30 is positioned to impart the driving force at a location along curved track portion 28, specifically at the center of curvature of portion 28. In this embodiment, slat support elements 12 are curved to match a curvature of curved track portion 28. The pair of slat support elements 12 with their teeth 14 mesh with drive mechanism 30 at the center of the periphery of the curved track 28, which ensures continuity of drive motion.

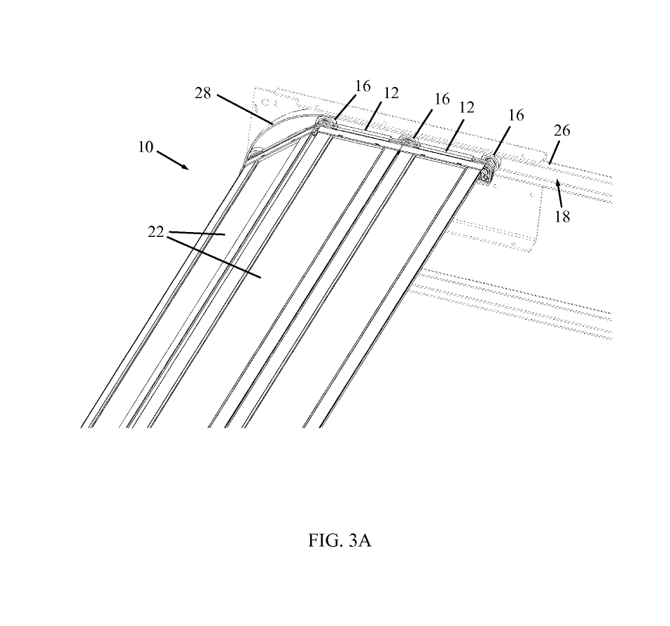

Reference is now made to FIGS. 3A and 3B, which are simplified upper and lower perspective illustrations, respectively, of apparatus 10. In FIG. 3B, which shows the underside of apparatus 10, it is seen that drive mechanism 30 may be one side of the apparatus 10 and connected through a drive axle 34 to the other side of apparatus 10. A sprocket wheel 36 that rotates together with drive mechanism 30 may be connected by a chain or other similar force-transfer device to actuator 32 (not shown in FIG. 3B).

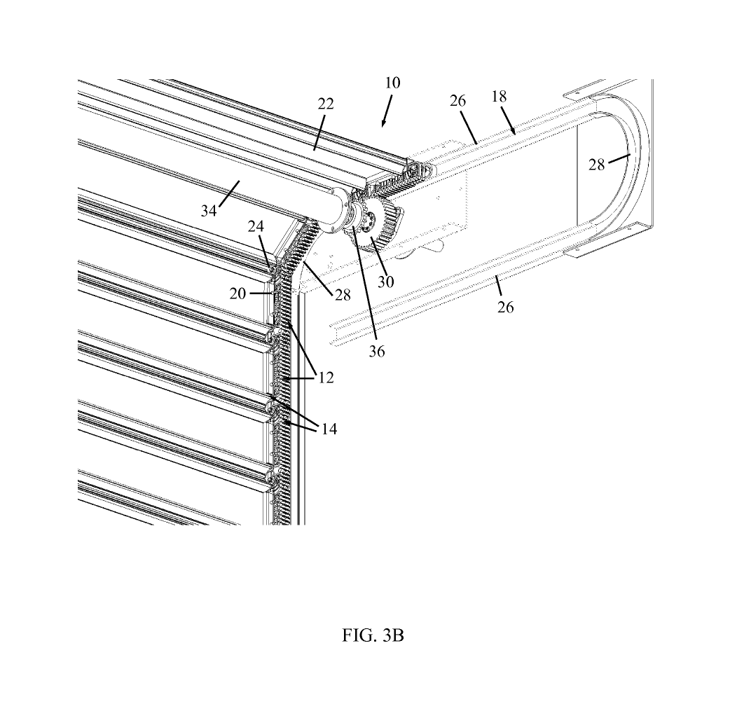

Reference is now made to FIGS. 4A and 4B, which illustrate a construction of slat support elements 12, in accordance with an embodiment of the present invention. In this embodiment, a pair of toothed members 38 having teeth 14 are assembled to each other with fasteners 40, which also fasten to slat mounting member 20. The slat mounting member 20 includes mounting hardware 42 for attachment to the slats. Movement member 16 may have an axle 44 that passes through pivot holes 46 formed in toothed members 38. Axle 44 is secured with a nut 48.

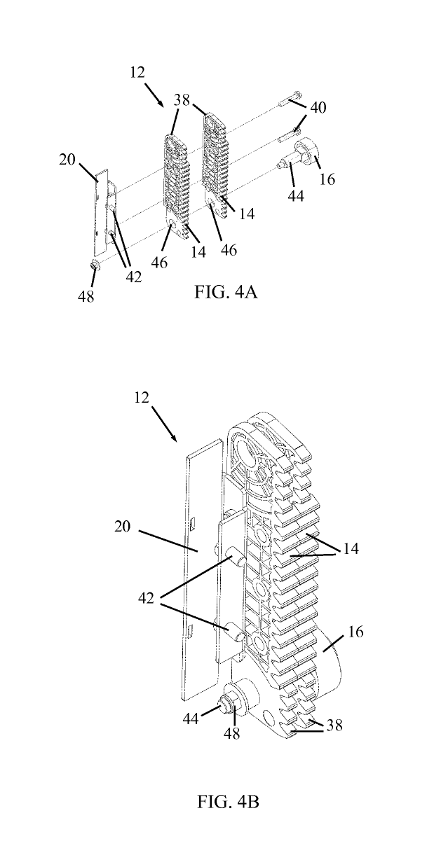

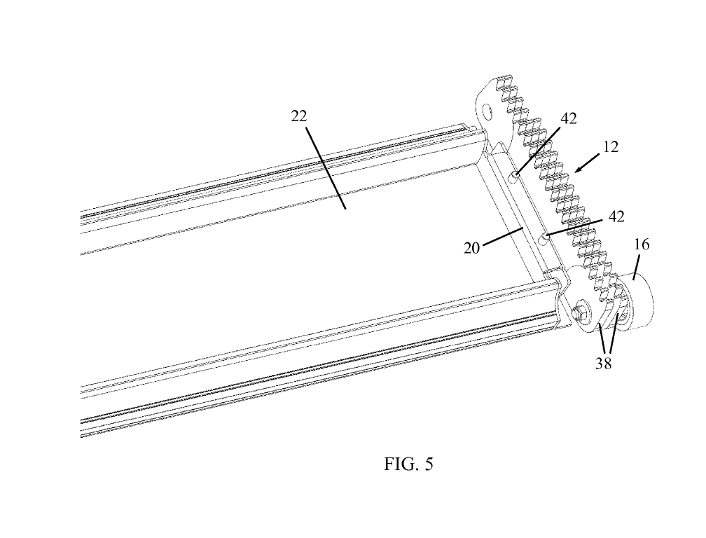

Reference is now made to FIGS. 5 and 6, which illustrates one of the slats 22 attached to one of the slat support elements 12 (detached therefrom in FIG. 6). It is seen, that in this embodiment, fasteners 42 of slat mounting member 20 are used to fasten with mounting holes 49 (FIG. 6) of slat 22 (such as threaded fasteners and a tapped hole, or pins that snap into the hole, or other fastening mechanisms). In this manner, slat 22 is removable from and attachable to slat mounting member 20 without removing slat support elements 12 from the track 18 (FIG. 6). Since each slat 22 is connected to slat mounting member 20 with only two fasteners 42, it is very easy to adapt different materials and designs for the slats, and replacing damaged slats.

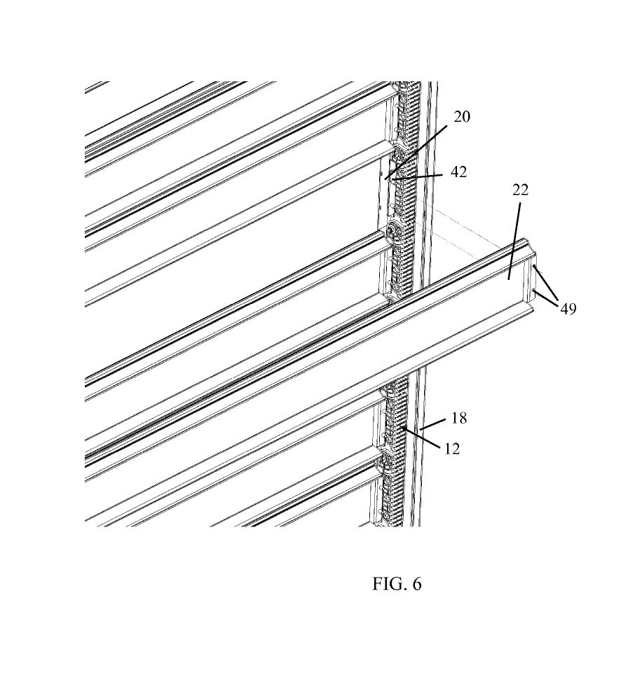

FIG. 7 illustrates another slat 22 attached to slat support element 12, in accordance with another embodiment of the present invention. In this embodiment, slat 22 includes a panel 50 that snaps together with slat frame profiles 52, which in turn are fastened together with slat mounting member 20 with suitable fasteners. Here again, slat 22 is removable from and attachable to slat mounting member 20 without removing slat support elements 12 from the track. Panel 50 and/or slat frame profiles 52 may provide thermal insulation, such as by being constructed of a material with good thermal insulation (e.g., plastics) and/or by a double wall construction.

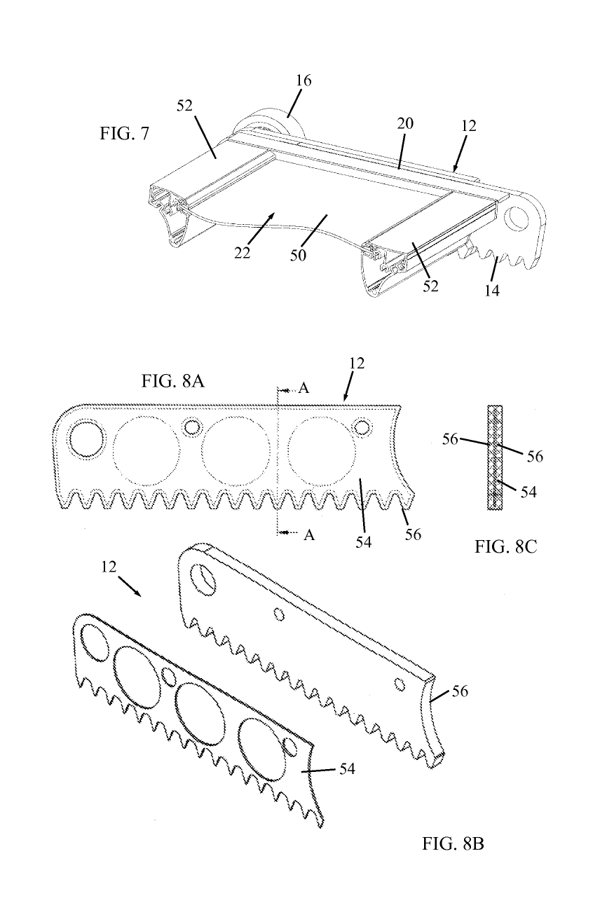

Reference is now made to FIGS. 8A, 8B and 8C, which illustrate another construction of slat support element 12, in accordance with an embodiment of the present invention. In this embodiment, slat support element 12 includes a metal layer 54 sandwiched between non-metallic (e.g., plastic) layers 56, which may be in the form of a hollow sleeve member. In this manner, the movement of slat support elements 12 in the track is smooth and silent, due to the non-metallic layers 56. In addition, if the non-metallic layers 56 wear over time, the metal layer 54 becomes exposed, thereby providing a visual and audible indication of the wear and alerting the user to replace the part.

The invention can be used with any door size. The option to mount the driving wheel inside the curve or outside the curve allows for flexibility for many types of installations.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A sliding door apparatus comprising:
a plurality of slat support elements, each comprising force-transfer members, a movement member and slat mounting members, said slat support elements being pivotally connected to one another and arranged for the movement members to travel along a track which has at least one straight track portion and at least one curved track portion;
a plurality of slats attached to said slat mounting members; and
a drive mechanism arranged to impart a driving force to said force-transfer members of said slat support elements so that said movement members travel along said track and pivot with respect to each other when passing through said at least one curved track portion.

2. The sliding door apparatus according to claim 1, wherein said drive mechanism is positioned to impart said driving force at a location along said at least one straight track portion.

3. The sliding door apparatus according to claim 1, wherein said drive mechanism is positioned to impart said driving force at a location along said at least one curved track portion.

4. The sliding door apparatus according to claim 1, wherein said force-transfer members comprise teeth and said drive mechanism comprises a gear that meshes with said teeth.

5. The sliding door apparatus according to claim 1, wherein said slat support elements are straight.

6. The sliding door apparatus according to claim 1, wherein said slat support elements are curved to match a curvature of said at least one curved track portion.

7. The sliding door apparatus according to claim 1, wherein said slats are removable from and attachable to said slat mounting members without removing said slat support elements from said track.

8. The sliding door apparatus according to claim 1, wherein said slats provide thermal insulation.

9. The sliding door apparatus according to claim 1, wherein said slat support elements comprise a metal layer sandwiched between non-metallic layers.
